(19) United States
(12) Patent Application Publication
(10) Pub. No.: US 2023/0286055 A1
(43) Pub. Date: Sep. 14, 2023

(54) THREE DIMENSIONAL PRINTER

(71) Applicant: ICON Technology, Inc., Austin, TX (US)

(72) Inventors: Jason Douglas Ballard, Austin, TX (US); Michael Dealon McDaniel, Austin, TX (US); Adam Douglas Leonards, Austin, TX (US); Christopher Perry Barton, Austin, TX (US)

(73) Assignee: ICON Technology, Inc., Austin, TX (US)

(21) Appl. No.: 18/120,388

(22) Filed: Mar. 11, 2023

Related U.S. Application Data
(60) Provisional application No. 63/319,251, filed on Mar. 11, 2022.

(51) Int. Cl. B22F 12/47; B22F 12/50; B22F 10/25; B22F 12/41

(52) U.S. Cl. CPC B22F 12/47; B22F 12/50; B22F 10/25; B22F 12/41; B33Y 30/00

(57) ABSTRACT

A three dimensional printer can include: at least one beam configured to support a shuttle for a printhead of the three dimensional printer; and at least one tower configured to support the at least one beam; where the at least one beam and the at least one tower include a frame having a structural design produced from an iterative design process that employs a generative design algorithm to optimize a shape and/or topology of the frame, thereby reducing a ratio of a total mass over a total print build volume of the three dimensional printer.

### CROSS-REFERENCE TO RELATED APPLICATIONS

This application claims the benefit of copending U.S. Provisional Patent Application No. 63/319,251, filed on Mar. 11, 2022 and titled, “THREE DIMENSIONAL PRINTER,” all of which is herein incorporated by reference in its entirety for all purposes.

### FIELD

The disclosure relates to in-situ construction and more specifically, to an iteratively designed modular three dimensional construction printer.

### BACKGROUND

Automated 3D printing of structures having a large build volume utilize large (e.g., massive) components to print the structure, scaling with the size of the build volume, e.g., larger print volumes require larger component dimensions, increasing mass and mechanical limits of the printer. Increased mass of the printer, increases the mass of supporting systems like rails, which can compromise operations, reliability, and print quality. Current approaches require a lot of auxiliary equipment, further increasing cost and time. Current approaches to design and manufacturing of the printer involves thousands of individual components. This creates a complex & vulnerable supply chain.

### SUMMARY

Disclosed herein is a three dimensional printer and embodiments thereof for use at build sites in which the structural elements of the printer, variations, and embodiments thereof have been iteratively designed (e.g., using a generative design algorithm) to optimize at least one parameter of the printer, such as a mass to stiffness ratio, or mass to print volume (build volume) ratio, or other operational characteristics. In some examples, a three dimensional (hereafter “3D”) printer includes structural elements, such as a tower and a beam, the beam supporting a “shuttle” or other substructure configured to have (e.g., mount, house, or otherwise support both structurally and functionally) a printhead (or “printer head,” used interchangeably herein throughout this Summary and the following Detailed Description, without restriction or limitation to any specific or individual embodiment or example (hereafter “embodiment” and “example” may be used interchangeably without limitation or restriction). The tower supports the beam and each element moves along at least one dimension such that the printhead can print a structure within the print volume of the printer.

The structural elements of the printer can be separately manufactured in sections using additive manufacturing and additive construction systems and techniques and assembled prior to, or at, the build site using materials shipped into a site or those that are already in-situ (i.e., on site) by processing raw materials readily available at a construction site location. Once assembled, the printer can transition from a folded state which facilitates ease of transportation, and an unfolded state in which the printer is capable of performing a printing process. In other words, the printer is transportable by collapsing or folding the beam(s) and tower(s) together or partially together and placed atop a transport such as on a flatbed truck or rail trailer or within a shipping container such as a container box or other enclosure that can be placed on a transport (e.g., a platform such as a flat bed truck, rail car, stacked on a container or other ship or vessel, or within the fuselage of an aircraft). In some examples, the printer may be transported inside of a shipping container or box, similar to those used on ships, trucks, and rail cars.

In general, one or more aspects of the subject matter described in this specification can be embodied in a three dimensional printer including: at least one beam configured to support a shuttle for a printhead of the three dimensional printer; and at least one tower configured to support the at least one beam; where the at least one beam and the at least one tower include a frame having a structural design produced from an iterative design process that employs a generative design algorithm such as a machine learning or deep learning algorithm(s) (trained or untrained, supervised or unsupervised) to optimize a shape, structure, architecture, and/or topology of the frame, thereby reducing a ratio of a total mass over a total print build volume of the three dimensional printer. The foregoing and other embodiments can optionally include one or more of the following features, alone or in combination.

A stiffness to mass ratio can be increased for the structural design of the frame produced by the generative design algorithm's optimization of the shape and/or topology of the frame. The stiffness of the frame can be sufficient to limit deflections at a delivery end of the printhead to less than a predefined percentage of a total available travelling distance of the printhead. A material of the frame and/or the structural design of the frame can be produced to handle a thermal cycling requirement, and both the thermal cycling requirement and the ratio of the total mass over the total print build volume of the three dimensional printer can enable deployment of the three dimensional printer on Earth and on Earth's moon. In other words, large temperature variations can be withstood by the material used to produce the printer enabling deployment, operation, and functioning of the printer in any terrestrial or non-terrestrial environments.

The frame can include sections that have been separately manufactured using one or more additive manufacturing systems and techniques. Each of the sections of the frame can include: three or more hollow poles arranged substantially parallel with a direction; and at least two hollow crossbars coupling the three or more hollow poles together; where each of the at least two hollow crossbars is (i) arranged at an angle of between thirty and sixty degrees away from the direction, and (ii) connects with two of the three or more hollow poles as an integral piece of material without an attachment mechanism between crossbar and pole.

In some examples, an integral piece of material connecting a hollow crossbar with a hollow pole can have a wall thickness that is greater at a point of intersection of the hollow crossbar with the hollow pole. The integral piece of material connecting a hollow crossbar with a hollow pole can include interior infill material configured and arranged to increase strength of the frame at a point of intersection of the hollow crossbar with the hollow pole. Further, at least one of the three or more hollow poles and at least one of the at least two hollow crossbars can include an interior structure that has been printed therein during the manufacturing of the frame section using the one or more additive manufacturing systems and techniques. The interior structure can be a cable raceway through which a cable of the three dimensional printer runs. The sections can each be between four and twenty feet in height, between two and eight feet in width, and between two and eight feet in depth.

The at least one tower and the at least one beam can be configured and arranged to fold together for transport and to unfold at a build site. The at least one tower can be three towers, the at least one beam can be three arms, and the three towers and the three arms can form a Delta printer. The at least one tower and the at least one beam can form a Cartesian printer. The at least one tower can be a single tower, the at least one beam can be a cantilever, and the single tower and the cantilever can form a boom tower printer. The at least one tower can be two towers, the at least one beam can be two beams, and the two towers and the two beams can form a gantry printer.

The at least one tower and the at least one beam can be located on a trailer for transport, by truck or rail or both, and can be configured and arranged to deploy (i.e., operate or function, including lifting, traversing, lowering, raising, moving, or otherwise articulating) directly from the trailer without use of a telehandler. The at least one tower and the at least one beam can be located on rails on the trailer for transport and can be configured and arranged to move on the rails during operation of the three dimensional printer to build a structure. The three dimensional printer can be a Cartesian and/or Polar coordinate three dimensional printer; in other words, the three dimensional printer can operate using a Cartesian and/or Polar coordinate system that is referenced to a set of coordinates on a site (i.e., construction or printing site) and movement of the printer can be directed in accordance with traversing coordinates determined using a Cartesian and/or Polar coordinate system. Moreover, the three dimensional printer can include a ballast system including one or more holders (e.g., container, hopper, or the like) to house ballast or other material found locally (i.e., in-situ) at a build site (e.g., construction site, printing site, or the like, without limitation or restriction).

In addition, one or more aspects of the subject matter described in this specification can be embodied in a method of manufacturing at least the frame of the three dimensional printer of any of the preceding embodiments, where the method includes: building the frame in sections using one or more additive manufacturing systems and techniques employing one or more of titanium, tantalum, tungsten, niobium, stainless steel, aluminum, copper, zircalloy, or one or more nickel alloys; and uniting the sections to form the frame. The uniting can include welding the sections together. Other manufacturing techniques are also possible. The building can include additively manufacturing each section of the frame using a directed energy deposition three dimensional printer. The directed energy deposition three dimensional printer can include an argon laser infusion three dimensional printer. Other additive manufacturing systems and techniques can be used.

Particular implementations of the subject matter described in this specification can be implemented so as to realize one or more of the following technical advantages. The printer disclosed can facilitate simpler, faster deployment at a build site which reduces project time scales and costs. The printer can be self-erecting which reduces the number of failure points of the system and increases ease of assembly. The printer disclosed can be composed of materials and be iteratively designed to provide increased precision of deposited materials and increased performance of the printed structure. Printers optimized for increased mass to print volume ratios can achieve large total print volumes including printed structures having one or more stories. The printer disclosed can be iteratively designed to reduce overall mass, which decreases the energy for transportation of the printer to a build site, and assembly of the printer at the build site. Reduced mass increases structural stability of the printer at build sites at which the underlying support surface is less stable. Finally, the printer disclosed can be manufactured from individual sections, and each individual section can be designed and manufactured to simplify assembly, which reduces the manufacturing time, energy, and costs while increasing the speed of transport of the sections, or elements.

The details of one or more embodiments are set forth in the accompanying drawings and the description below. Other features and advantages may be apparent from the description and drawings, and from the claims.

### BRIEF DESCRIPTION OF THE DRAWINGS

Various embodiments of the invention are disclosed in the following detailed description and the accompanying drawings:

FIG. 1 is a schematic illustration depicting a perspective view of an example of a three dimensional printer.

FIG. 2A is a schematic illustration depicting a plan view of an example of a three dimensional printer.

FIG. 2B is a schematic illustration depicting a cross sectional view of a rail system of the three dimensional printer of FIG. 2A.

FIG. 2C is a schematic illustration depicting a plan view of a rail system of the three dimensional printer of FIG. 2A.

FIG. 3 is a sequence of images depicting a design process employing a generative design algorithm.

FIGS. 4A-4C are schematic illustrations depicting three examples of beams designed using the disclosed design process.

FIG. 5A is a schematic illustration depicting a beam assembled from individual sections of the beam.

FIG. 5B are schematic illustrations depicting a tower and a beam assembled from individual sections.

FIG. 6 is a sequence of schematic illustrations depicting cross sectional views of four examples of designs of a pole and a cross arm intersection.

FIG. 7 is a sequence of heat map illustrations depicting simulated stresses of a beam undergoing a load at a point along the beam.

FIG. 8A is a schematic illustration depicting a printer configured to have a folded state capable of transportation on a transport.

FIG. 8B is a schematic illustration depicting a printer configured to have an unfolded state capable printing from a transport.

FIG. 9 is a sequence of schematic illustrations depicting perspective views of three unfolding processes for three respective printers.

FIG. 10 is a schematic illustration depicting a perspective view of an example of a gantry-style three dimensional printer.

In the figures, like references indicate like elements.

### DETAILED DESCRIPTION

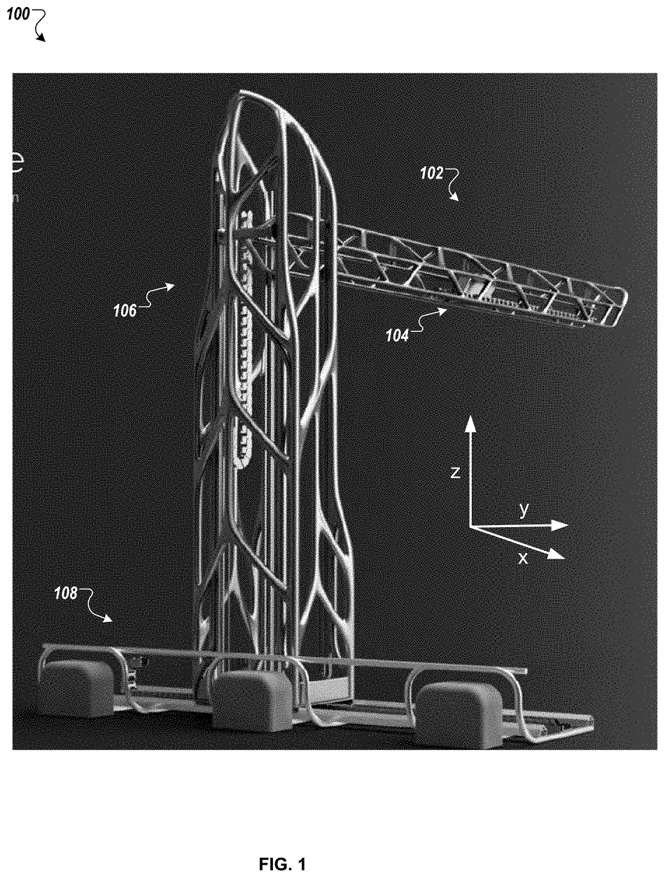

FIG. 1 is a schematic illustration of an example of a three dimensional printer 100 constructed having an optimized shape (e.g., topology) which reduces the ratio of total mass to total print (build) volume. The printer 100 includes a beam 102 movably supported by a tower 106, the beam 102 movably supporting a shuttle 104. The single beam 102 extending from and supported by the tower 106 is a cantilevered beam 102, and the printer 100 including a single beam 102 supported by the tower 106 can be termed a boom tower printer.

The tower 106 is movably supported by a rail system 108, which is disposed on a supporting surface, such as a ground surface. The tower 106 is movable along the rail system 108 along a first dimension (e.g., the x-dimension of the inset reference perspective axes), the beam 102 is movable along the tower 106 in a second dimension (e.g., the z dimension), and the shuttle 104 is movable along the beam 102 in a third dimension. In some implementations, the dimensions are a Cartesian coordinate system in which each axis is orthogonal to the other axes, e.g., a Cartesian printer. In some implementations, the tower 106, shuttle 104, or beam 102 are movable in a rotational motion, e.g., rotated along an axis of rotation. Thus, the 3D printer 100 can operate using a polar coordinate system.

In some implementations, the boom tower 3D printer (“boom tower 3D printer” may refer interchangeably, and without limitation or restriction, to printer 100) is mounted on a rail based system for its Y-axis which means it is Cartesian, but the boom tower 3D printer can also be mounted on a rotary base as a Polar printer, e.g., for mobile, lunar, terrestrial, non-terrestrial, space-based, and off-world applications, or on top of a climbing tower crane structure to radially print high rises or other multiple story structures, habitable or non-habitable. In the case of deployment from a mobile transport or transportation system, such as a truck or rail trailer, the boom tower 3D printer (i.e., printer 100) may be mounted on both a rail system and on a rotary base, making the 3D printer both a Cartesian printer and a Polar printer, e.g., the boom tower (i.e., tower 106) can both slide in a linear motion (e.g., along the fifty feet length of the trailer) and also rotate at each end of that linear range of motion. This provides the boom tower 3D printer a significantly larger print (build) volume/envelope for a given size of the tower and the boom. Moreover, in some implementations, the delivery end of the printhead on the shuttle can be moved in the z dimension, irrespective of whether or not the beam 102 is movable along the tower 106 in the z dimension.

In some implementations, the printer 100 includes more than one tower 106, more than one beam 102, or both. For example, a printer 100 including three towers 106, each having a single beam 102, the towers 106 can be arranged in a triangular formation having the respective beams 102 extending to the interior of the triangular formation and being connected with a shared shuttle 104. In other examples, a printer 100 can include a different number of towers, beams, and arms and are not limited to any specific number or quantity. Regardless, such configurations can be termed a Delta printer. Other printer configurations are also possible, such as a gantry printer configuration.

The printer 100 includes actuators, e.g., motors, to induce motion in the beam 102 along the tower 106, and actuators to induce motion in the shuttle 104 along the beam 102. In some implementations, the tower 106 includes a housing in which one or more actuators, wiring, or controllers are located to protect the components from the surrounding environment, e.g., from dust or radiation. In some implementations, the shuttle 104 houses one or more actuators to induce motion along the beam.

Some or all of the structural elements, such as tower 106 or the beam 102, of the printer 100 are composed of a rigid material, such as a metal or metallic alloy. In some implementations, the structural elements can be built from titanium, tantalum, tungsten, niobium, stainless steel, aluminum, copper, zircalloy, or one or more nickel alloys. For example, aluminum or titanium compounds can include compounds such as Ti-6A1-4V, AlSi10Mg, or Al 6061. Structural elements composed of aluminum or titanium compounds can reduce overall mass of the printer 100 compared to other rigid metals, such as stainless steel.

In some implementations, the structural elements of the printer 100 are composed of a material capable of handling, e.g., resistant to, thermal cycling. In some implementations, the printing site, e.g., the build site, on which the printer 100 is assembled experiences wide (e.g., >20° C.) differences in a high temperature and a low temperature during the printing process. As a first example, a build site on Earth's moon can experience a difference in maximal and minimal temperatures of at least 100° C. (e.g., at least 120° C., at least 140° C., at least 180° C., or at least 200° C.). The printer 100 undergoing a thermal cycle can undergo a temperature difference from a maximum temperature to a minimum temperature. In some implementations, the thermal cycle includes undergoing a maximum temperature, a minimum temperature, and a second maximum temperature. The printer 100 can be designed or manufactured to undergo thermal cycling on Earth, Earth's moon, Mars, and other planetary bodies in the solar system. Examples of thermally resistant materials can include, but are not limited to, metals such as titanium, tungsten, molybdenum, or nickel, or metallic alloys containing these metals.

The tower 106, beam 102, or both, can optionally include housings and supports for cabling, wiring, or both. The wiring communicates power or electronic commands to the electronic components of the printer 100, including actuators, shuttle 104, controllers, or sensors of the printer 100. In implementations including cabling, the cabling transfers mechanical force to the interconnected components of the printer 100, such as cabling to induce motion of the beam 102 along the tower 106, or cabling to induce motion of the shuttle 104 along the beam 102. In some implementations, the printer 100 includes rigid track systems on which the beam 102 and shuttle 104 move along their respective supports.

The printer 100 includes a controller having a non-transitory storage medium and at least one processer, the medium storing software including commands for the electronically connected components of the printer 100 which, when executed by at least one processer, cause the printer 100 to perform the function of printing a structure on the surface. The controller can cause the motion of the tower 106, the beam 102, or the shuttle 104. The controller can cause a printing material to be delivered to the shuttle 104 using one or more delivery devices, e.g., pumps or augurs.

The shuttle 104 includes a printhead which can include a receptacle for receiving the printing material and a delivery end for delivering the printing material to a receiving surface, such as the surface on which the printer 100 is assembled, or a surface of a printed structure. In some implementations, the shuttle 104 includes one or more delivery devices which impel the printing material to the delivery end. The shuttle 104 can include one or more sensors which measure respective values of one or more printing process parameters. The process parameters can include, but are not limited to, parameters of the printed structure, printing material, or printer 100 environment.

In some implementations, the printing materials can undergo a transition, e.g., a phase transition, under directed energy, such as being melted and solidifying as a solid structure. In such implementations, the shuttle 104 can include one or more energy projection devices, e.g., lasers, infrared beams, or electron beams, to project energy at the deposited printing material which can cause the phase transition and solidify the printed structure.

For example, printing material parameters can include parameters which affect the outcome of the printing processes. The specific material parameters may depend on the category of the material. For example, material parameters for granular materials (e.g., sands, metallic powders) can include material composition (e.g., percentages of various silicates), grain size (fineness), density, and moisture absorption. As another example, material parameters for liquids can include pH level, salinity, calcium carbonate levels, etc. As another example, material parameters for admixtures can include temperature, viscosity, and/or solids content.

Examples of environmental parameters include air temperature, air humidity, wind speed, precipitation, etc., at a build site. Examples of process parameters can include pump speed, pump pressure, flow speed, mixing speed, mixing time, material ratios, mix ratios, etc. Examples of printing parameters can include print speed, lift times, bead width, dispensing rate, dispensing temperature, or bead height.

In some implementations, the structural elements of the printer 100 can be manufactured using additive manufacturing techniques (e.g., 3D printing). For example, the structural elements can be manufactured using directed energy deposition techniques, such as using an argon laser infusion three dimensional printer. In some implementations, the structural elements of the printer 100 can be manufactured using subtractive manufacturing systems and techniques, or both subtractive and additive manufacturing systems and techniques. For example, the structural elements of the printer 100 can be manufactured using additive manufacturing techniques, and the frame sections can be finished (e.g., polished or cleaned) before assembling the printer 100. In some implementations, the printer 100 is assembled on a pre-existing tower structure, e.g., a tower crane.

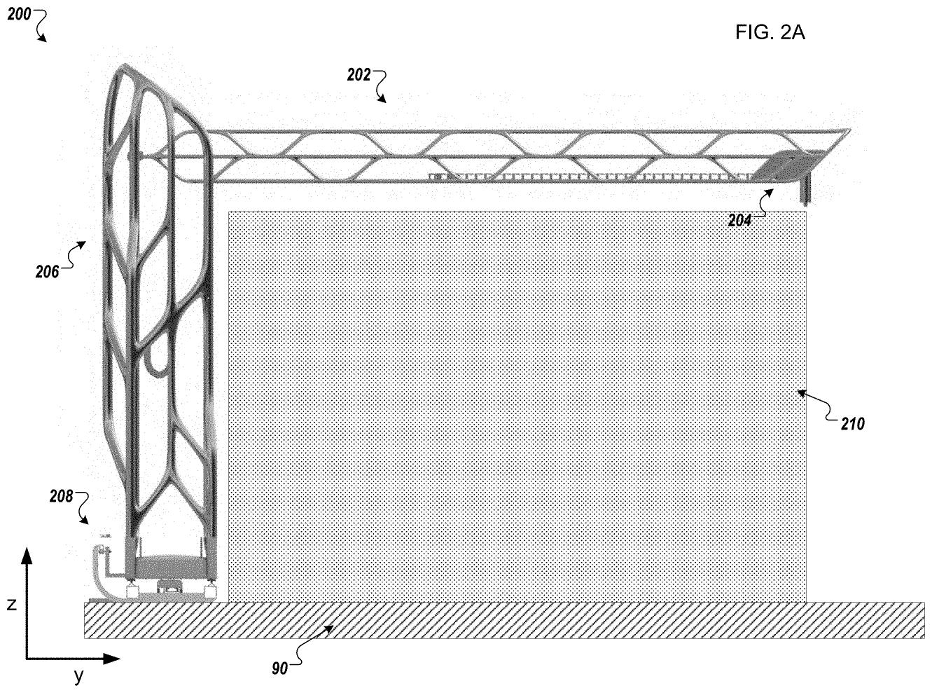

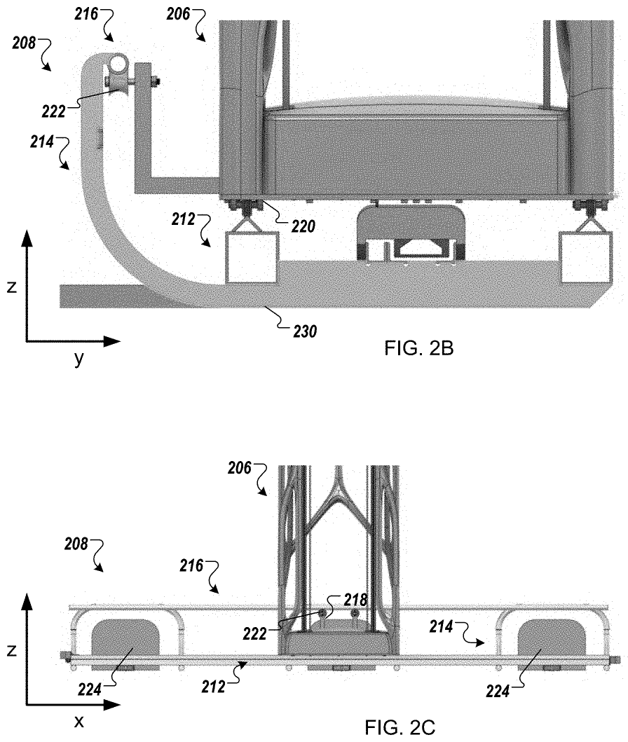

FIG. 2A is a side view of a second example of a printer 200, including a tower 206, beam 202, and shuttle 204 assembled on a surface 90. The second printer 200 can provide the printer 100 shown in FIG. 1. The shuttle 204 is shown extending to an end of the beam 202, opposite the end movably supported by the tower 206. The printer 200 has a structural design that reduces total deflection as measured from the end of the beam 202 for the provided amount the total print (build) volume 210 of the printer 200. The print volume 210 of the printer 200 is defined by the three dimensional volume of a space in which the printer 200 is capable of printing a structure. The maximal dimensions of the print volume 210 extend along the total range of motion of the printer 200, e.g., from maximal and minimal positions along the x-, y-, and z-dimensions. For example, the print volume 210 can extend from the surface 90 to the surface of the shuttle 204 nearest the surface 90 when the beam 202 is at the maximum height above the surface 90, e.g., along the z-axis, from one end of the rail system 208 to the opposite end, or from the shuttle 204 position nearest the tower 206 to the shuttle 204 position furthest from the tower 206.

In implementations in which the printer 200 is a Cartesian printer, the print volume 210 is substantially rectangular and can extend twenty five feet in a first dimension, forty feet in a second dimension, and 100 feet in a third dimension. For example, the beam 202 can have an overall length (e.g., from one end of the beam 202 to an opposing end along the y-axis) in a range from 10 feet (ft) to 50 ft (e.g., 15 ft, 20 ft, 25 ft, 30 ft, 35 ft, 40 ft, 45 ft, or 48 ft). The tower 206 can have an overall height (e.g., from one end of the tower 106 to an opposing end along the z-axis) in a range from 10 feet (ft) to 50 ft (e.g., 15 ft, 20 ft, 25 ft, 30 ft, 35 ft, 40 ft, 45 ft, or 48 ft).

Referring now to FIGS. 2B and 2C, schematic illustrations depicting a cross sectional view, and a plan view, of the rail system 208, respectively, are shown. The tower 206 is arranged to couple with the rail system 208. The tower 206 includes wheels 220 which are in contact with rails 212 which extend in parallel in a first linear direction (e.g., the x-direction). A support 218 extends from the base of the tower 206 such that a guide roller 222 contacts a load rail 216. The load rail 216 is attached to a base 230 by a load arm 214. In general, when the printer 200 is assembled, the base 230 is disposed on the surface 90.

The rail system 208 can include at least one ballast block 224. The ballast block 224 is a weighted object which provides inertial mass to the rail system 208. The increased inertial mass of the rail system 208 increases structural stability of the rail system 208 and the printer 200. In some implementations, the ballast block(s) 224 are constructed from, or filled with, material found locally at the build site.

When the tower 206 is installed on the rail system 208, the tower 206 can be moved between one end of the rail system 208 and the opposing end, providing a first range of motion to the printer 200. In some implementations, the tower 206 is configured to rotate in the plane of the rail system 208 in additional to linear motion along the rail system 208.

The shapes (and optionally the topology) of the structural members of the tower 206 and beam 202 are iteratively designed (e.g., using output from a generative design algorithm) to reduce the total mass of the tower 206 and the beam 202 while ensuring sufficient stiffness of the tower 206 and beam 202 to provide accurate 3D printing control over the large print (build) volume. In some implementations, the shape and topology of the tower 206 and beam 202 are iteratively designed to increase structural stiffness (e.g., the rigidity of a structural element, i.e., the extent to which the element is able to resist deformation or deflection under an applied force). Reducing the overall mass of the printer 100 increases structural stability on surfaces on which the printer 100 is assembled, reduces energy and costs related to transportation, facilitates increased overall dimensions of the printer 100, which increases the total print volume the printer 100 is capable of printing a structure within.

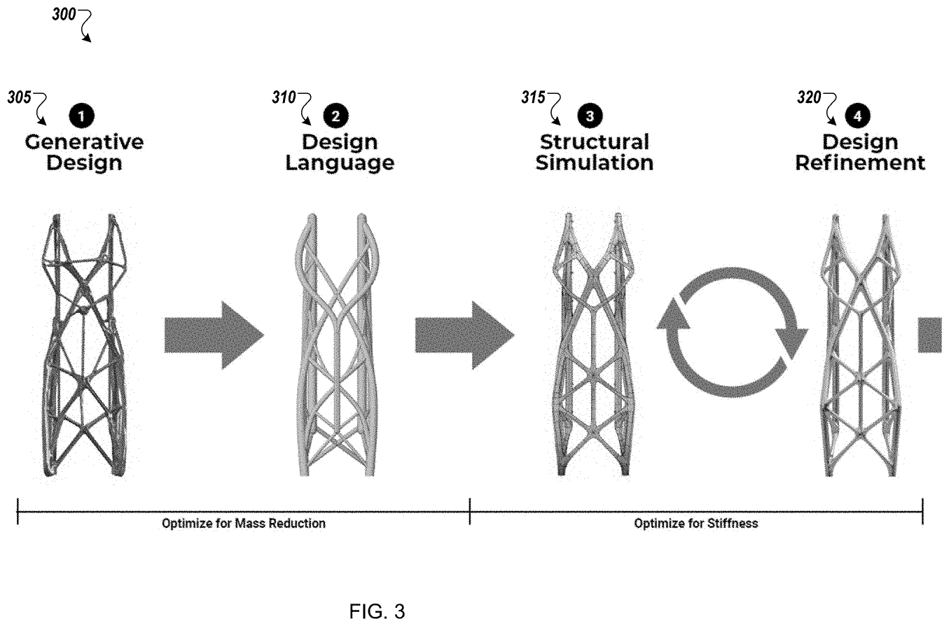

Referring to FIG. 3, the design process 300 for the components of the printer 100 can include a generative design step 305, a translation of the generative design to a design language 310, a structural simulation step 315, and a design refinement step 320. The design process 300 of FIG. 3 depicts a tower design undergoing the steps of the process. In general, a generative design process 300 is an iterative design process that involves an algorithm which generates a certain number of outputs, e.g., a structural design, that meet certain constraints, e.g., one or more load points, one or more keep out regions, etc. The output is translated to a design language which can by iterated by a designer, e.g., a designer may fine tune the one or more regions of the design by selecting specific output or changing input values, ranges and distribution. One or more steps of the design process 300 can be performed by a computing device (e.g., a computer, a server, a networked device), an algorithm, e.g., an artificial intelligence, or a user.

The generative design step 305 is performed by an algorithm which receives one or more constraints. Examples of constraints can include but are not limited to one or more load points, one or more keep out regions, one or more material parameters, one or more dimensions (e.g., a height, width, or length), one or more element structural parameter (e.g., a stiffness, a rigidity, a torsional rigidity), or one or more threshold values corresponding to one or more corresponding parameters (e.g., a maximum dimension, a maximum mass, a minimum stiffness). For example, the material parameters can include a composition, such as Ti-6A1-4V, AlSi10Mg, or Al 6061. In some implementations, the generative design algorithm used is found in commercially available computer aided design software, such as Fusion360®, available from Autodesk, Inc. of San Rafael, Calif.

In some implementations, the algorithm can be an artificial neural network, a generative adversarial network, or a generative design algorithm, and can include other rule-based computational tools, such as finite element method and topology optimization. The algorithm produces an output which meets the received constraints. The output can include a data file storing data representative of a structural element topology, such as the tower topology depicted in FIG. 3.

In some implementations, the constraints the algorithm may receive include a set of load points that the component can expect to experience during a printing and/or assembling process. In some implementations, the algorithm can receive exclusion regions (e.g., keep out zones) corresponding to void spaces in the output design. In such implementations, the set of load points correspond to points on the tower which experience a load during the printing or assembling process. The received constraints facilitate the creation of a design mesh as output by the algorithm.

The design language step 310 is performed by receiving the output of the generative design step 305 and converting the output to a first design which can include a topology of the design element. In some implementations, the design language step 310 is performed on a computing device.

The structural simulation step 315 is performed by computationally implementing the element in a virtual environment and performing an engineering analysis on the element against applied loads, e.g., using Finite Element Analysis (FEA) processes. The engineering analysis determines one or more values for corresponding engineering parameters of the element, such as a deflection value, a mass value, or a stiffness value. For example, the applied load may be a downward load (e.g., along the longitudinal axis of the structural element), a horizontal load (e.g., perpendicular to the longitudinal axis of the structural element), and/or a torque load (e.g., around an axis parallel with, or perpendicular to, the longitudinal axis of the structural element).

The design refinement step 320 is performed by receiving the engineering analysis of the structural simulation step 315 and determining one or more alterations to the element design to affect a change in the value of one or more engineering parameter of the design.

In some implementations, the design process 300 is performed iteratively, in which the output from one of steps 305, 310, 315, and 320 is used as input to another step. For example, following the design refinement step 320, the output element design including the one or more alterations can be used in steps 305, 310, or 315 as input. The design process 300 can be iterated until one or more structural element design outcomes are achieved, such as a structural element mass, safety factor, failure load threshold, stiffness, or mass to stiffness ratio.

In general, a first part of the design process 300 involves optimizing the shape and/or topology of the structure for mass reduction, and a second part of the design process 300 involves optimizing the shape(s) of the structures for stiffness. One or more generative design tools can be used in the first part of the design process 300 to get an initial design concept that human designers then use as a basis for their industrial design work. The output of the generative design algorithm can be used like a like sketch of force lines to use in the structures of designs. The designs produced by the designers based on the generative design tool's outputs can then be run thru a process cycle of refinement where various simulations are run on the design to gauge various metrics that the design needs to perform at a certain level to be deemed functional. If a design does not meet expectations then it is redesigned, and the same simulations are run on the new design. This process continues until the design archives its objectives. Then, the printer design can be moved into prototyping via 3D-printing of the 3D printer, e.g., in sections.

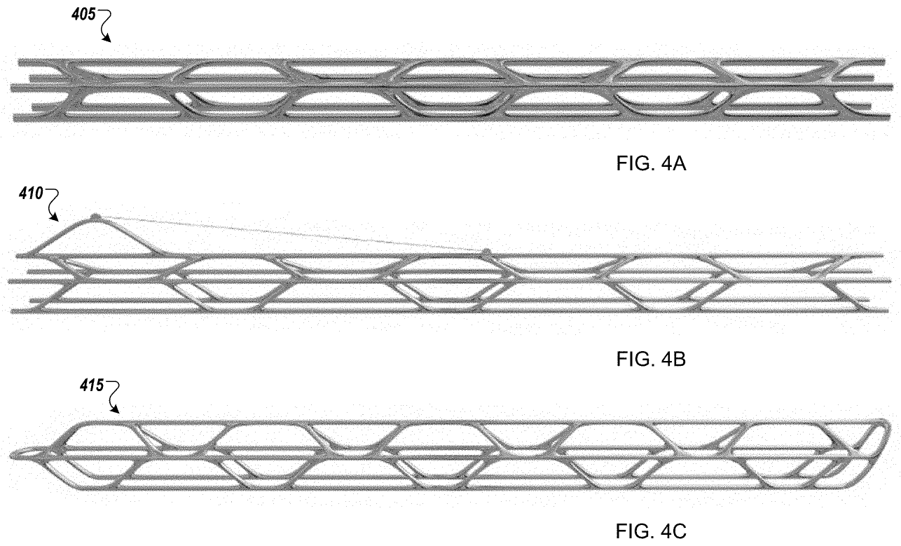

Referring to FIGS. 4A-4C, various examples of beams are shown which can provide beam 202. FIG. 4A depicts a beam 405 optimized for mechanical strength via (cross sectional) profile shape and joint optimization(s). FIG. 4B depicts a beam 410 configured to include a cable support to strengthen the structure. Such implementations can facilitate increased beam 410 length and reduced beam 410 mass by increasing mechanical support of the beam 410 at a point along the length. FIG. 4C depicts a beam 415 designed to include an in-fill material in the support structures of the beam 415.

In some implementations, a structural element of the printer can be generatively designed in a unitary body, e.g., as a whole element. In some implementations, the structural element can be generatively designed in more than one section, e.g., as distinct or repeating sections of the structural element, which sections can be assembled to form the structural element. In further optional embodiments, the structural element can be generatively designed in a unitary body, and the structural element so designed can then be subdivided into two or more sections. The subsequent sections can then be manufactured, e.g., additively manufactured, and assembled, e.g., welded, to form the structural element of the 3D printer.

In some implementations, the designed sections can have dimensions that facilitate any one of manufacturing, transport, or assembly of the structural elements. For example, the sections can be each between four and twenty feet in height, between two and eight feet in width, and between two and eight feet in depth.

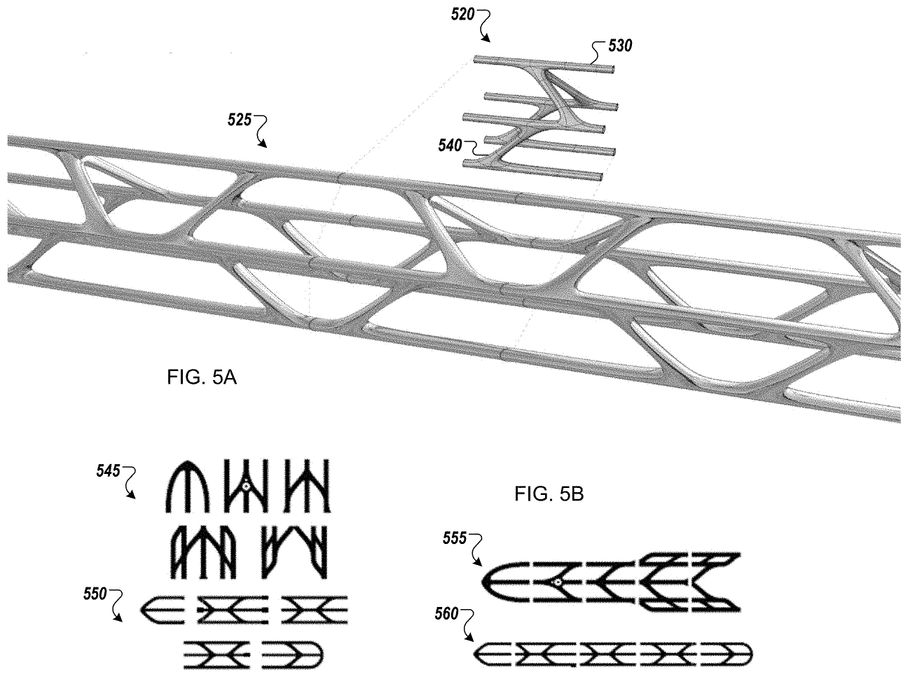

Referring now to FIG. 5A, a depiction of a section 520 of a larger element design 525 is shown. The design of the section 520 can be optimized using the processes described herein and subsequently manufactured into the larger element 525, or the larger element 525 can be optimized using the processes described herein and then be split into section(s) 520 for manufacturing. The section 520 includes substantially parallel poles 530 extending in a first direction, and crossbars 540 supporting the spatial orientation of the poles 530 and maintaining the shape of the section 520 under a force load. Each of the crossbars 540 connects two of the poles 530 and each of the poles 530 are connected by at least one of the crossbars 540. In some implementations, the crossbars 540 are integrally manufactured with the poles 530, e.g., without an attachment mechanism between crossbars 540 and poles 530.

Section 520 includes four parallel poles 530, though in general the section 520 can include three or more poles 530. The crossbars 540 are oriented at an angle with respect to the direction of the poles 530. In general, the crossbars 540 can be oriented at an angle in a range between thirty and sixty degrees from the direction of the poles 530 (e.g., between 35 and 55 degrees, or between 40 and 50 degrees). The section 520 can be manufactured and optionally assembled into element 525, e.g., a tower or a beam.

Each section 520 of the 3D printer to be manufactured can be built using additive manufacturing systems and techniques. In some implementations, a directed energy deposition (DED) 3D printer is used to build each section 520. The DED 3D printer used to build the sections of the 3D printer can employ a powder DED technique, such as laser metal deposition (LMD) or laser engineered net shaping (LENS), or a wire DED technique, such as electron beam additive manufacturing. Other options for 3D printing the 3D printer's structures, aside from using a DED 3D printer, include: (1) molten metal extrusion, (2) powder bed fusion, such as selective laser sintering (SLS) and electron beam melting (EBM), TIG like welding, binder jetting, and sheet lamination. Note that the limits on the dimensions of each section 520 of the 3D printer (i.e., where the dimensions fall in the noted ranges of four to twenty feet in height, two to eight feet in width, and two to eight feet in depth) can depend on the specific additive manufacturing systems and techniques selected for manufacturing the sections 520.

In addition, subtractive manufacturing systems and techniques can be used in addition to the additive manufacturing systems and techniques. The 3D-printed structural elements of the 3D printer can have drilling, CNC machining, heat treating, coatings, or other processes performed on the parts before or after they are joined together and welded into place. CNC machining, drilling, or chemical processes can be performed to allow for tighter tolerances in alignment/fit of structures together, or to prepare the surfaces for welding or affixing to the other printed members. In some instances, the 3D-printed parts may require heat treating once they are printed and before more heat is added when they are welded together. Moreover, other process, such as grinding, sanding, polishing, or chemical processes can be used to achieve the final surface quality needed for various applications. For example, a highly polished surface of a 3D-printed part may be needed in lunar applications to reflect sunlight and keep the printed structure of the robotic 3D printer cooler on the surface during daylight applications.

Referring now to FIG. 5B, examples of sections of a tower 545 and examples of sections of a beam 550 are depicted. The sections of a tower 545 and the sections of a beam 550 can be arranged into the structure of a tower 555 or a beam 560, respectively, and be united using methods relevant to the materials from which the sections of a tower 545 and the sections of a beam 550 are manufactured. For example, sections 520, 545, and 550 manufactured from a metal or metallic allow can be welded (e.g., sintered, MIG welded, TIG welded) together to form tower 555 or beam 560.

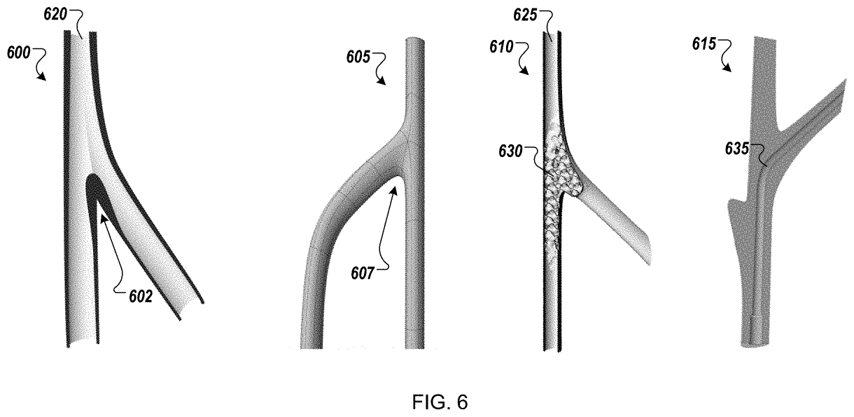

In some implementations, the design of a structural element includes voids within the elements, such as hollow poles 530 or crossbars 540, elements having in-fill structures, or one or more raceways through which lines, e.g., cables or wires, can be run. Referring now to FIG. 6, various designs of portions of a structural element are shown, including a section of a pole and a section of a crossbar.

Hollow design 600 depicts a cross section for a pole and a crossbar in which a void 620 is formed in the pole and crossbar. The void 620 extends between both ends of the pole through an end of the crossbar. The walls of the hollow design 600 have a thickness of manufactured material. In some implementations, the thickness of the walls varies along the length of the pole or the crossbar. For example, hollow design 600 includes increased wall thickness at the acute intersection 602 of the crossbar and the pole. Such designs have decreased mass and improved engineering parameters.

Solid or hollow design 605 depicts a pole and a crossbar in which a blended intersection 607 is used. Note that a blended intersection 607 and/or an increased wall thickness intersection 602 can be used with the additional designs described below.

In-fill design 610 depicts a cross section of a pole and a crossbar in which a void 625 is formed in a portion of the pole and crossbar, and an in-fill structure 630 is manufactured in a portion of the void. An example of the in-fill structure 630 can include an interconnected series of walls forming void features in various arrangements. In some implementations, the in-fill structure 630 is a regular array of void features, such as a honeycomb structure. In some implementations, the void 625 is partially filled by the in-fill structure 630, and in alternative implementations, the void is fully filled by the in-fill structure 630. In-fill design 610 includes the in-fill structure 630 filling the intersectional void between the pole and the crossbar. Such designs have increased total mass and improved engineering parameters, compared to hollow design 600, while decreased total mass compared to solid design 605. In some implementations, the in-fill structure 630 operates as ballast for the printer, increasing mass in a portion of the structural element which increases structural stability of the printer when assembled.

Raceway design 615 depicts a cross section of a pole and a crossbar in which a raceway 635 is formed in a portion of the pole and crossbar. In some implementations, the raceway 635 is a channel sized to receive a wire or cable and can include one or more structures to provide tension or stabilization to the cable or wire. The raceway 635 can protect the received cable or wire from external environments, reduce wear on vulnerable cabling and wiring, or have increased structural stiffness due to internal tensioning. The cable/wire can be used to support one or more parts of the printer, e.g., a part of a cantilevered 3D printer structure.

In some implementations, one or more additional components can be built into (3D printed inside) the frame of the 3D printer to improve the operation of the 3D printer and/or reduce costs/complexity of manufacturing. Thus, various additional components can be included in the design, such as any of designs 600, 605, 610, or 615. Such additional components can include attachment points, mounting brackets, cavities, or enclosures to facilitate manufacturing, construction, assembly, or support of structural elements, or improve one or more outcomes of the printing process, such as print speed, boom or tower stability, or print accuracy.

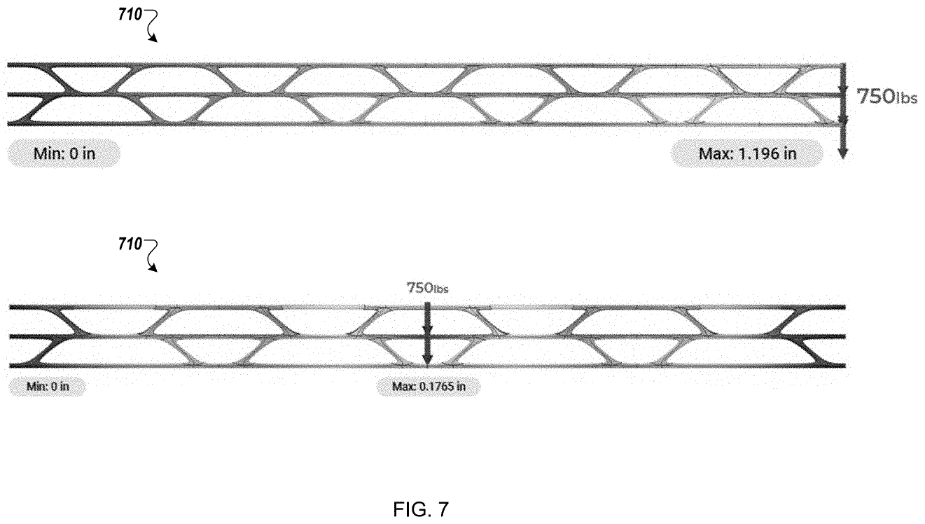

In some implementations, the printer can be configured to achieve a deflection threshold, e.g., displacement, based on a load applied to a point along a structural element. Referring now to FIG. 7, simulated heat maps of stresses along the length of a simulated beam 710 are shown. In a first image, a simulated load of 750 pounds (lbs) is shown (arrows) applied to an end of the simulated beam 710. In this image, the opposing end of the beam 710 is fixed in space in the simulation. The printer can be configured to achieve a deflection threshold of less than an inch (e.g., less than % of an inch, or less than ½ of an inch) in situations in which a 750 pound load is applied to an end of the beam.

In the second image, a simulated load of 750 pounds (lbs) is shown (arrows) applied to a point of the beam 710, such as a point equidistant between the ends of the beam 710, e.g., the middle of the beam 710. In this image, an end of the beam 710 is fixed in space in the simulation. The printer can be configured to achieve a deflection threshold of less than an inch (e.g., less than % of an inch, or less than ½ of an inch) in situations in which a 750 pound load is applied to a point on the beam 710, such as a point equidistant between the ends of the beam 710.

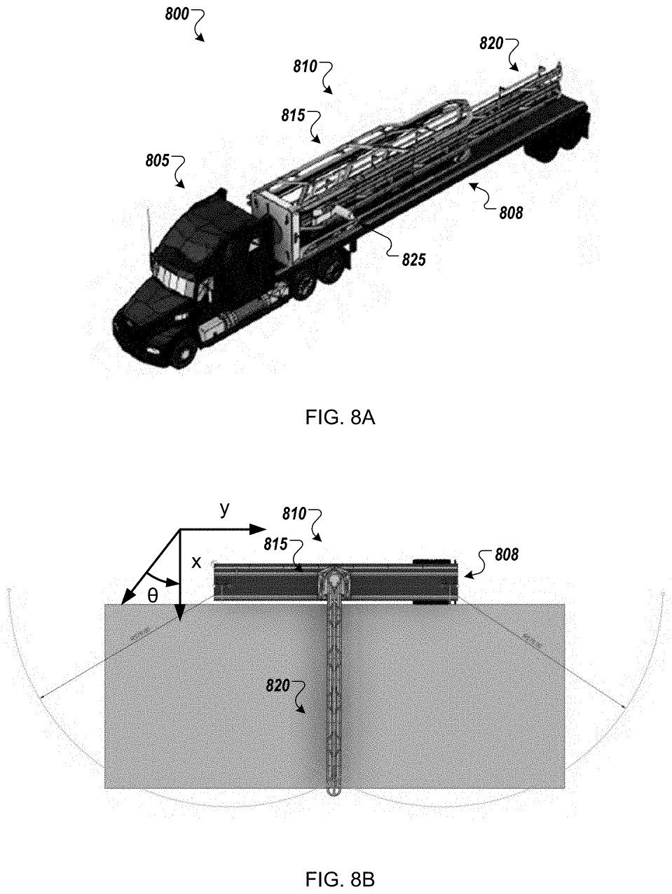

In some implementations, the printer can be configured and arranged to fold together for transport, to unfold at a build site, or both. As an example, referring now to FIG. 8A, a printing transport system 800 is depicted including a transport 805, e.g., truck, tractor, or semi-trailer, and three dimensional printer 810 configured for transport. The printer 810 is configured such that the tower 815 and beam 820 are arranged along a common axis, e.g., in parallel. The shuttle 825 is arranged within the beam 820. Alternative examples of transport 805 can include rail transports, such as a flatbed rail car, or dedicated/integrated mobility transports integrated with the printer 810, e.g., a wheel system, such as for construction on Earth's moon, on Mars, and/or on other planetary bodies in the solar system.

The printer 810 is configured to be arranged on a trailer 808 of the transport 805 while not exceeding various rules regulating the transport of large-size objects. In some implementations, the printer 810 is configured to remain within one or more guidelines governing the transport of over-sized load, e.g., a wide-load. The configuration of the printer 810 is substantially linear and fits within standardized dimensions for transport of items. In some implementations, the standards are U.S. Department of Transportation standards for semi-trailer dimensions, such less than or equal to 53 ft in length, 8.5 ft in width, or 13.5 ft in height. In some implementations, the standards are corporation standards for launch to at least orbit.

In some implementations, the printer 810 can be configured to print a structure while in an unfolded state and arranged on the trailer 808. FIG. 8B depicts the printer 810 in an unfolded state, arranged on the trailer 808 which includes a rail system. Such implementations, in some examples, may be implemented directly at a build site with or without the use of an external lifting system (e.g., a telehandler or telescopic handler). The printer 810, or integrated or remote controller, can control the y-position of the printer 810 along the rail system. The tower 815 is arranged extending away from the trailer 808, e.g., vertically, along the z-axis, with the beam 820 extending outward (e.g., along the x-y plane) from the tower 815 over the print volume.

In some implementations, the printer 810 is configured to rotate in at least one direction. In the example of FIG. 8B, the printer 810 can rotate in an azimuthal direction, θ. Rotation of the printer 810 in an azimuthal direction can increase the total print volume achievable by the printer 810 by extending the maximal dimensions of the print volume. Note that the printer 810 can print on both sides of the trailer 808.

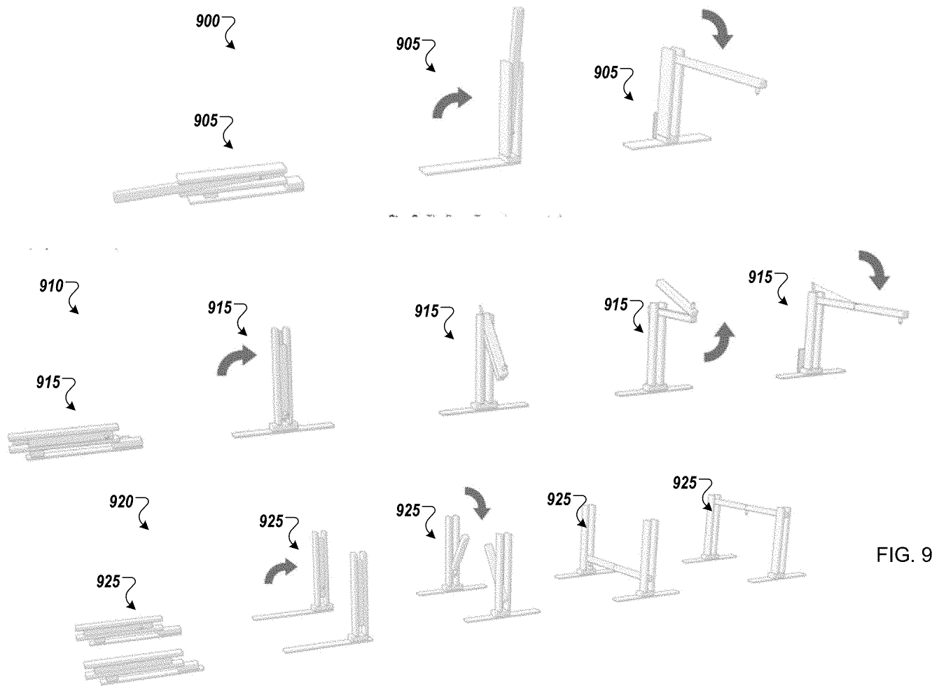

The unfolding process for a printer can depend on the configuration of the printer. Referring now to FIG. 9, three examples of unfolding processes are depicted, in which a printer transitions from a folded state to an unfolded state. In general, the folded states are all configured for transport to a build site. In some implementations, the printer can transition from the folded state to the unfolded state without external power or support, e.g., the printer is self-assembling. In general, the unfolded states are printing-capable states in which the printer may produce a printed structure.

Unfolding process 900 depicts printer 905 transitioning from a folded state (left-most image) to an unfolded state (right-most image). The printer 905 depicted is a boom tower printer. The tower of the printer 905 rotates in a first plane to extend orthogonally from the rail system. The beam of the printer 905 then rotates in a second plane to extend orthogonally from the tower.

Unfolding process 910 depicts printer 915 transitioning from a folded state (left-most image) to an unfolded state (right-most image). The printer 915 depicted is a supported-boom tower printer. The printer 915 includes an articulated beam including two sections, a first section rotatably attached to the tower, and a second section, rotatably attached to the first section. The printer 915 includes a cable system further supporting the first section from the tower, such as the beam 410 of FIG. 4B. The tower of the printer 905 rotates in a first plane to extend orthogonally from the rail system. The first section of the beam of the printer 915 then rotates in a second plane to extend orthogonally from the tower. The second section of the beam of the printer 915 then rotates in the second plane to extend orthogonally from the tower, parallel to the first section.

Unfolding process 920 depicts printer 925 transitioning from a folded state (left-most image) to an unfolded state (right-most image). The printer 925 depicted is a gantry printer, including two towers, two rail systems, and two beams which can assembly together to form a gantry. The towers of the printer 925 rotate in a first plane to extend orthogonally from the rail systems. The beams of the towers then rotate in a second plane to extend orthogonally from the tower. The beams of the towers can then assemble into a gantry extending between the respective towers.

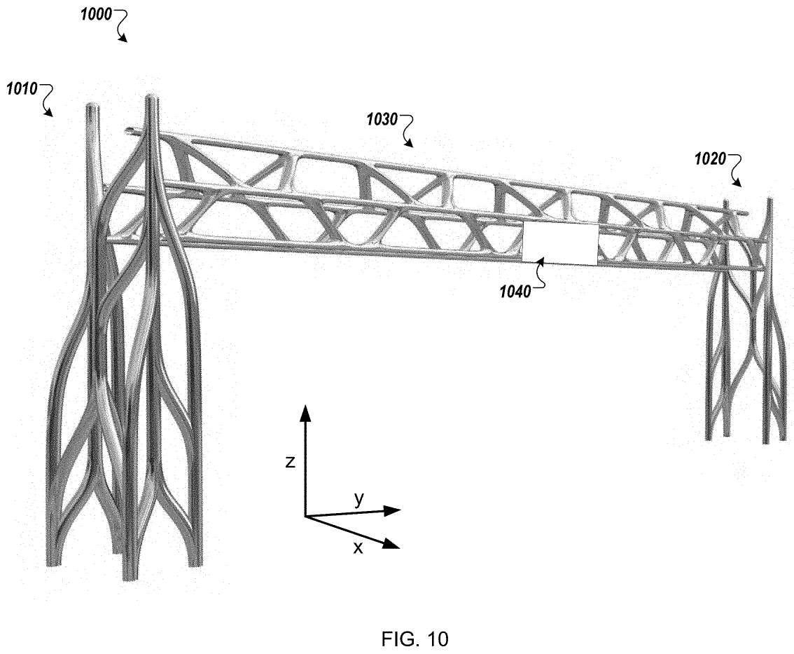

FIG. 10 depicts an example of a gantry printer 1000. The printer 1000 includes a first tower 1010 and a second tower 1020. The printer 1000 includes a beam 1030 extending between the first tower 1010 and the second tower 1020. The beam 1030 can be movably attached to the first tower 1010 and second tower 1020 such that the beam 1030 moves along the plane defined by the orientation of the first tower 1010 and the second tower 1020. A shuttle 1040 is movably supported by the beam 1030 and configured to travel between the first tower 1010 and the second tower 1020. In this manner, configurations in which the printer 1000 includes parallel rail systems for each of the first tower 1010 and the second tower 1020, the print volume extends along all three Cartesian coordinate axes of the inset reference frame. In some implementations, the printer 1000 can be assembled from two boom-style printers, such as in unfolding process 920.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of implementations have been described. Nevertheless, it may be understood that various modifications may be made without departing from the spirit and scope of the invention. Accordingly, other implementations are within the scope of the following claims.

1. A three dimensional printer comprising:
a beam configured to support a shuttle housing a printhead, the shuttle being coupled to the tower;
a tower configured to support the beam; and
a frame comprising the beam and the tower, the frame having a structural design produced using an iterative design process performed by a generative design algorithm to optimize a shape or topology of the frame by reducing a ratio of a total mass over a total print build volume of the three dimensional printer.

2. The three dimensional printer of claim 1, wherein a stiffness to mass ratio of the frame is increased by the generative design algorithm, the generative design algorithm optimizing the shape or the topology of the frame.

3. The three dimensional printer of claim 1, wherein a stiffness of the frame is configured to limit a deflection at a delivery end of the printhead to less than a predefined percentage of a total available travelling distance of the printhead.

4. The three dimensional printer of claim 1, wherein the frame comprises one or more sections generated using additive manufacturing.

5. The three dimensional printer of claim 1, wherein each section of the frame comprises:
a plurality of hollow poles arranged substantially parallel with a direction; and
a plurality of hollow crossbars coupling the plurality of hollow poles together;
wherein each of the plurality of hollow crossbars is (i) arranged at an angle of between thirty and sixty degrees away from the direction, and (ii) couples to one or more of the plurality of hollow poles as an integral piece of material without an attachment mechanism between the plurality of hollow crossbars and the plurality of hollow poles.

6. The three dimensional printer of claim 5, wherein the integral piece of material connecting at least one of the plurality of hollow crossbars with at least one of the hollow poles has a wall thickness that is greater at a point of intersection of the at least one of the plurality of hollow crossbars with the at least one of the plurality of hollow poles.

7. The three dimensional printer of claim 5, wherein the integral piece of material connecting at least one of the plurality of hollow crossbars with at least one of the plurality of hollow poles comprises interior infill material configured to increase a strength of the frame at a point of intersection of the at least one of the plurality of hollow crossbars with at least one of the plurality of hollow poles.

8. The three dimensional printer of claim 5, wherein at least one of the plurality of hollow poles and at least one of the plurality of hollow crossbars include an interior structure that has been printed during the manufacturing of the frame section by using additive manufacturing.

9. The three dimensional printer of claim 1, wherein the tower and the beam are transportable by collapsing the tower and the beam together onto a transport.

10. The three dimensional printer of claim 1, wherein the beam comprises an arm, and the tower and the arm are configured to form a Delta printer.

11. The three dimensional printer of claim 1, wherein the tower and the beam are configured to form a Cartesian printer.

12. The three dimensional printer of claim 1, wherein the beam is a cantilever, the tower and the cantilever forming a boom tower printer.

13. The three dimensional printer of claim 1, wherein the tower and the beam are configured to form a gantry printer.

14. The three dimensional printer of claim 1, wherein the tower and the beam are disposed on a trailer, the tower and the beam being configured to operate from the trailer.

15. The three dimensional printer of claim 1, wherein the tower and the beam are coupled to a rail on a trailer, the tower and the beam being configured to move on the rail during operation of the three dimensional printer.

16. The three dimensional printer of claim 1, wherein the three dimensional printer uses a Cartesian coordinate system.

17. The three dimensional printer of claim 1, further comprising a ballast system including a holder configured to receive and store ballast material found at a build site.

18. A method, comprising:
building a frame by printing one or more sections using additive manufacturing, the frame being built using one or more of titanium, tantalum, tungsten, niobium, stainless steel, aluminum, copper, zircalloy, or nickel alloy; and
coupling the one or more sections to form the frame.

19. The method of claim 18, wherein the coupling comprises welding the one or more sections together.

20. The method of claim 18, wherein the building further comprises additively manufacturing each of the one or more sections using a three dimensional printer configured to use directed energy deposition.

21. The method of claim 20, wherein the three dimensional printer configured to use directed energy deposition uses argon laser infusion as the directed energy deposition.
